(19) United States
(12) Patent Application Publication
(10) Pub. No.: US 2012/0064776 A1
(43) Pub. Date: Mar. 15, 2012

(54) RECEPTACLE CONNECTOR HAVING A STABILIZING OUTER SHELL

(75) Inventors: QING-MAN ZHU, Kunshan (CN); CHIEN-CHIUNG WANG, New Taipei (TW); JIANG-HONG WU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/232,186

(22) Filed: Sep. 14, 2011

(30) Foreign Application Priority Data
Sep. 14, 2010 (TW) 099217735

(51) Int. Cl. H01R 24/28

(52) U.S. Cl. 439/660

(57) ABSTRACT

A receptacle connector assembly (200) includes a panel (4) and a receptacle connector (100). The receptacle connector adapted to be mounted onto the panel for mating with a plug connector (300) having a plurality of first terminals (311) and a shielding shell (320) enclosing the first terminals. The receptacle connector comprises an insulative housing (1) comprising a base section (10) and a mating section (12) extending from the base section having at least one opening (121) for receiving the first terminals, a plurality of second terminals (16) mounted in the at least one opening, and an outer shell (2) having a sleeve (22) enclosing around the mating section. The sleeve and mating section enclose a slot (60) therebetween for receiving the shielding shell of the plug connector stably.

### BACKGROUND OF THE INVENTION

1. Field of the Invention

The present invention relates to a connector, more particularly to a shield receptacle connector mounted on a panel.

2. Description of Related Art

In communication applications, a cable plug having a shell mating with a shielded receptacle mounted on a display or monitor is widely used. Generally, a locking mechanism is assembled to either side of the plug for preventing the plug from moving along with the cable. The locking mechanism locks the plug with the receptacle along a mating direction. However, design and arrangement of the plug shell and the locking mechanism does not stably support the cable plug such that the plug is still apt to shake or move up and down relative to the receptacle.

U.S. Pat. No. 6,273,742, issued to Castagna on May 28, 1999, discloses a plug having another locking mechanism. The locking mechanism includes a pair of plug screws for fixing the plug to a receptacle. The plug screw prevents the plug from shaking relative to the receptacle or loosing from the receptacle. It is not convenient to assemble these screws when mating or un-mating the plug with the receptacle.

Hence, a receptacle connector having an improved shell design is desired.

### SUMMARY OF THE INVENTION

Accordingly, an object of the present invention is to provide a receptacle connector assembly including a receptacle connector and a panel. The receptacle connector is adapted to be mounted onto the panel for mating with a plug connector having a plurality of terminals and a shielding shell separately enclosing the terminals. The receptacle connector comprises an insulative housing comprising a base section and a mating section extending from the base section and having at least one opening for receiving the plug terminals, a plurality of terminals received in the opening, and an outer shell enclosing around the insulative housing and having a sleeve enclosing around the mating section. The sleeve and the mating section encloses a slot therebetween for receiving the shielding shell of the plug connector.

The receptacle connector further has a pair of bolts respectively mounted on each fixing portions. The bolt has a headed cap for locking with the plug connector for preventing the plug connector loosing from the receptacle along a mating direction. The receptacle connector has an improved locking mechanism through adding the outer shell. Thus, the plug connector can be latched with the receptacle connector securely and easily without plug screws.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing a plug connector and a receptacle connector mounted on a panel according to the present invention;

FIG. 2 is a perspective view showing the plug connector shown in FIG. 1;

FIG. 3 is a perspective view showing the receptacle connector shown in FIG. 1;

FIG. 4 is a perspective view showing the receptacle connector mounted on the panel shown in FIG. 1;

FIG. 5 is an exploded view showing the receptacle connector as shown in FIG. 3;

FIG. 6 is an exploded view showing the receptacle connector and the panel shown in FIG. 3; and

FIG. 7 is a perspective view showing a receptacle connector and a panel according to a second embodiment.

### DETAILED DESCRIPTION OF THE PREFERRED EMBODIMENT

Reference will now be made in detail to the preferred embodiment of the present invention.

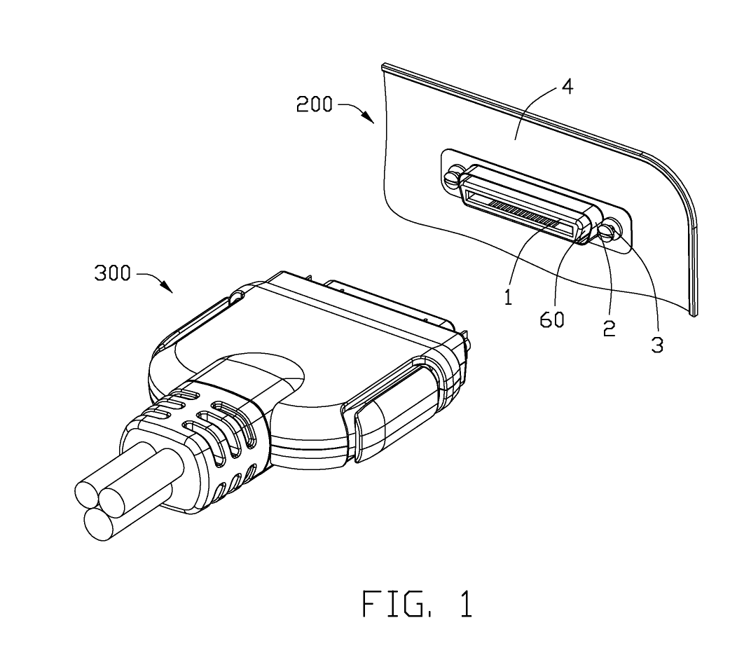

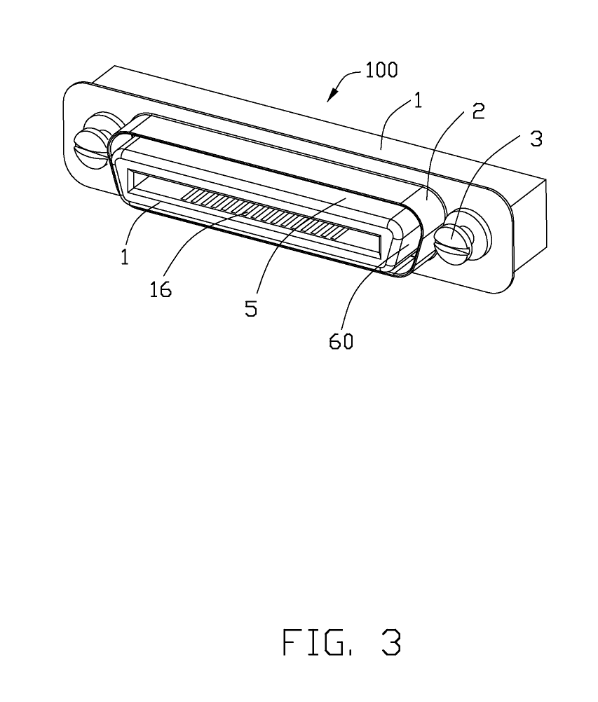

Referring to FIGS. 1, 3, and 5, a receptacle connector assembly 200 includes a panel 4 and a receptacle connector 100 mounted on the panel 4. The receptacle connector 100 has an insulative housing 1, a number of second terminals 16 mounted in the insulative housing 1, an inner shell 5 covering the insulative housing 1, an outer shell 2 enclosing around the inner shell 5, and a pair of bolts 3. These bolts 3 assemble the outer shell 2 to the insulative housing 1.

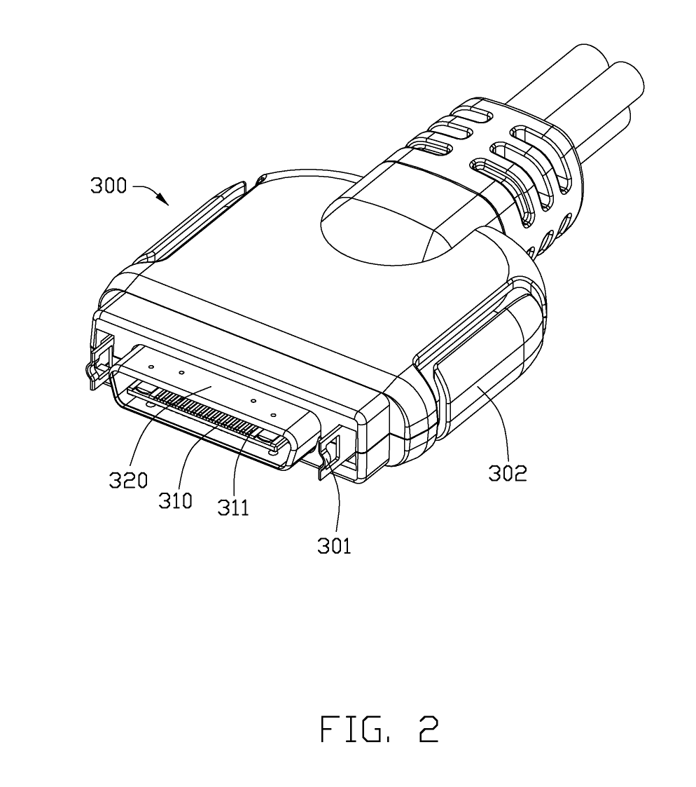

Referring to FIG. 2, the plug connector 300 has a tongue portion 310 and a shielding shell 320 separately enclosing the tongue portion 310. The plug connector 300 has a number of first terminals 311 mounted on the tongue portion 310 for contacting with the second terminals 16 mounted in the insulative housing 1 for transmitting signals or power. The plug connector 300 further has a latching mechanism including a latching lever having an operator 302 and a latching portion 301 locking with the headed cap 32. The latching portion 301 locking with the headed cap 32 for preventing the plug connector 300 loosing from the receptacle connector 100 along a mating direction. The latching portion 301 will release the headed cap 32 when the operator 302 is pressed inwardly.

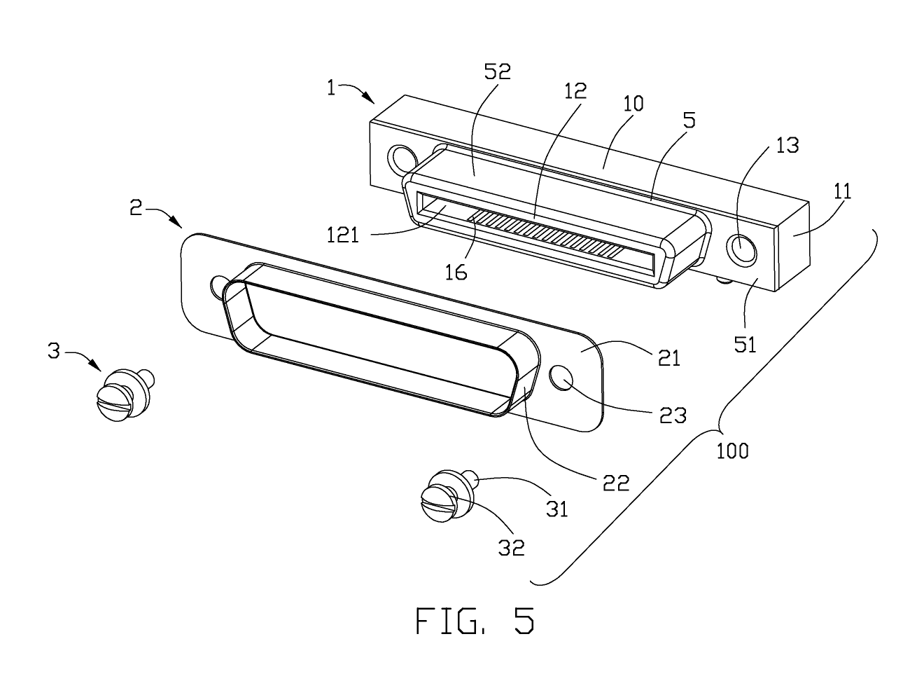

Referring to FIG. 5, the insulative housing 1 has a base section 10, a mating section 12 extending from the base section 10 defining at least one opening 121 for receiving the first terminals 311. The second terminals 16 of the receptacle connector 100 are positioned in the opening 121. The insulative housing 1 has a pair of fixing portions 11 extending laterally from the base section 10. Each of the fixing portions has a mounting hole 13 for mounting the bolt 3. Each of the bolts 3 has a headed cap 32 and a pole 31.

In other embodiments of the present invention, the mating section 12 could comprise a number of openings 121 for receiving the second terminals 16 individually. In this situation, each of the second terminals 16 is engaged in each of the openings 121. The first terminals could be mounted on the plug connector 300 without a tongue portion 310.

The inner shell 5 comprises a bush 52 for covering the mating section 12, and a pair of sidepieces 51 extending laterally from the bush 52 for covering the fixing portions 11. The inner shell 5 is fixed or adhered to the insulative housing 1. The inner shell and the insulative housing 1 have the common mounting holes 13. The bush 52 is adapted to be received in the shielding shell 320 securely and stably.

The outer shell 2 has a sleeve 22 enclosing around the bush 52. The outer shell 2 further has a pair of fixing plates 21 extending laterally and oppositely from the sleeve 22 for mounting the outer shell 2 onto the base section 11. Each of the fixing plates 21 comprises a through hole 23 for inserting the bolt 3 for assembling the outer shell 2 to the insulative housing 1.

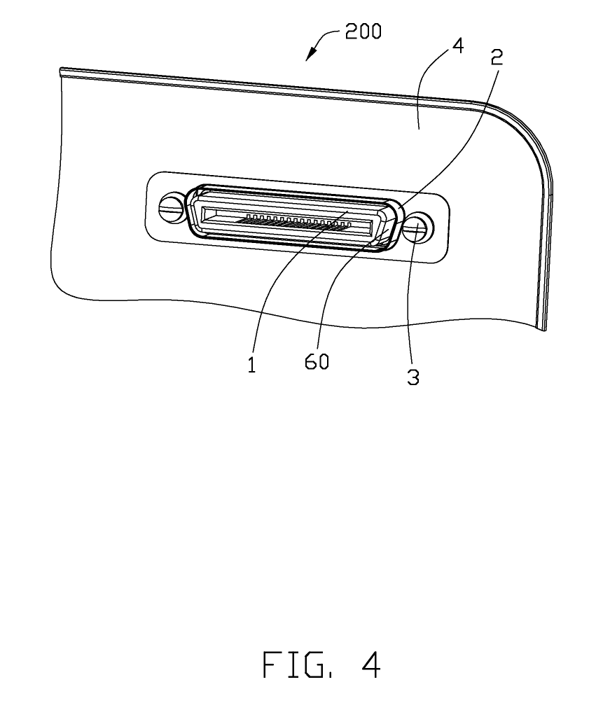

Referring to FIG. 4, the receptacle connector 100 has a circled slot 60 between the sleeve 22 and bush 52 for receiving and clipping the shielding shell 320. The sleeve 22 engages the shielding shell 320 tightly for preventing the plug connector 300 from shaking relative to the receptacle connector 100.

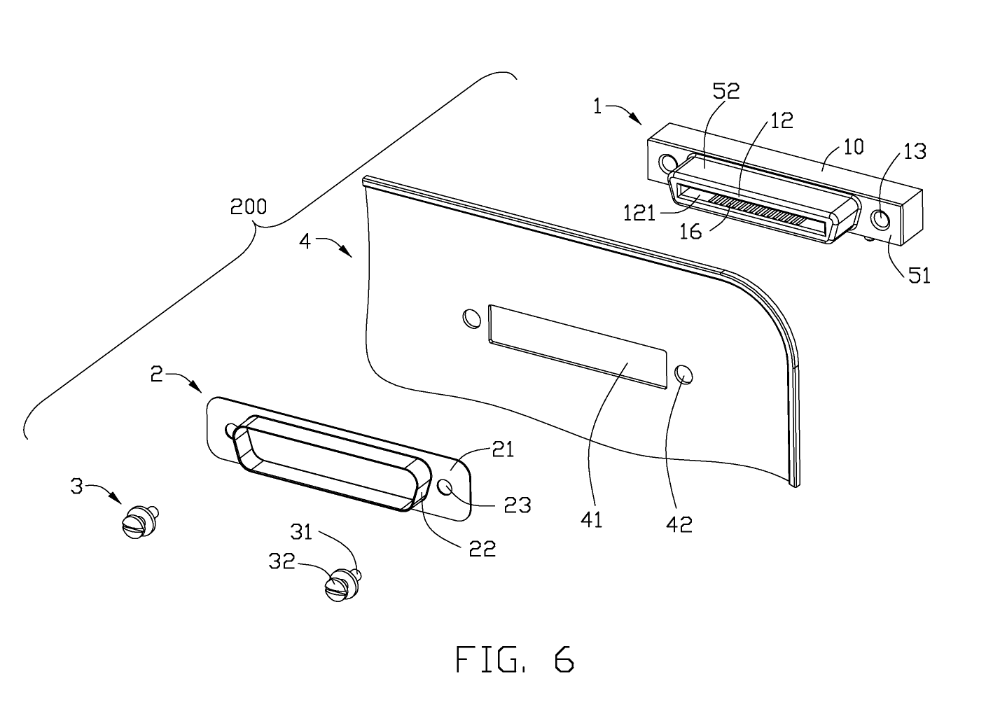

Referring to FIG. 6, the panel 4 defines a cutout 41 for receiving the bush 52 and a pair of screw holes 42. The through hole 23 and the mounting hole 13 are aligned with the screw hole 42 for receiving the bolt 3. Thus, the outer shell 2, insulative housing 1, and panel 4 can be assembled together by inserting the pole 31 axially. The bush 52 extends out of the cutout 41 to be received in the sleeve 22. The bolt 3 is fixed on the insulative housing 1. The panel 4 is positioned between the outer shell 2 and the insulative housing 1 as shown in FIG. 4.

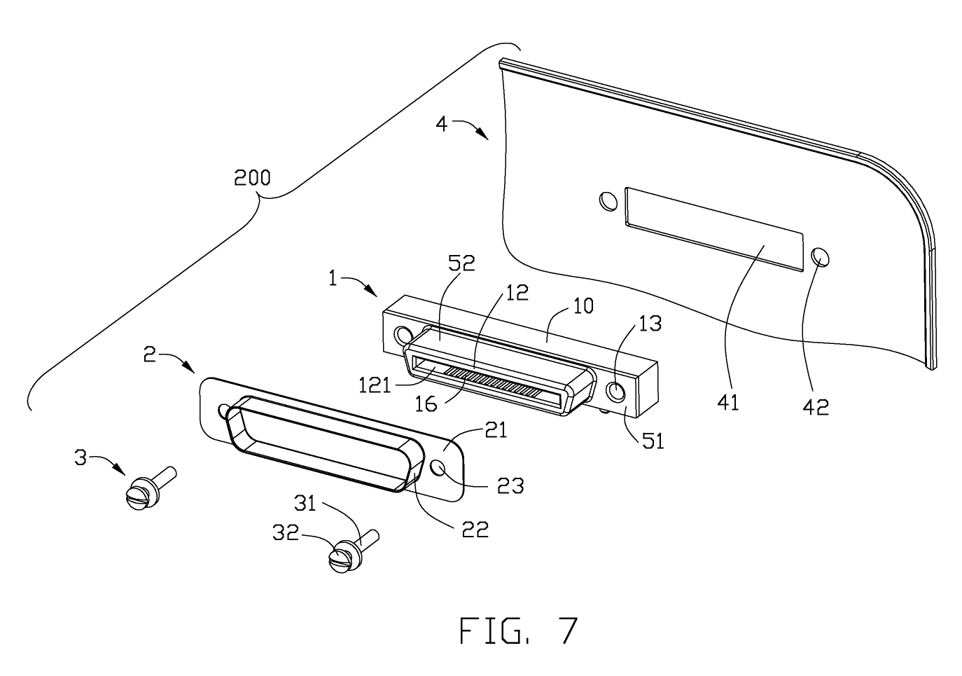

Referring to FIG. 7, in a second embodiment, the panel 4 is positioned behind the insulative housing 1. The bolt 3 is fixed on the panel 4 after inserting through the mounting hole 13.

In the present invention, the receptacle connector 100 has an additional outer shell 2 mounted therein for composing an improved locking mechanism, the plug connector can be connected quickly, securely and easily.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A receptacle connector adapted to be mounted onto a panel for mating with a plug having a plurality of first terminals and a shielding shell enclosing the first terminals, comprising:
an insulative housing comprising a base section and a mating section extending from the base section, the mating portion having at least one opening for receiving the first terminals;
a plurality of second terminals received in the at least one opening for contacting with the first terminals; and
an outer shell having a sleeve enclosing around the mating section, the sleeve and the mating section enclosing a slot therebetween for receiving the shielding shell.

2. The receptacle connector as claimed in claim 1, further including an inner shell comprising a bush enclosing around the mating section of the insulative housing, said bush being adapted to be received in the shielding shell.

3. The receptacle connector as claimed in claim 2, wherein said inner shell is fixed to the insulative housing.

4. The receptacle connector as claimed in claim 1, further including a pair of bolts, and wherein the insulative housing has a pair of fixing portions laterally and oppositely extending from the base section, each fixing portion having a mounting hole for receiving the bolt for fixing the receptacle connector to the panel.

5. The receptacle connector as claimed in claim 4, wherein said outer shell has a pair of fixing plates extending laterally and oppositely from the sleeve, said fixing plates assembled to the fixing portions of the insulative housing.

6. The receptacle connector as claimed in claim 5, wherein the fixing plate includes a through hole aligning to the mounting hole for receiving the bolt.

7. The receptacle connector as claimed in claim 4, wherein the bolt has a headed cap for latching with the plug.

8. A receptacle connector assembly, comprising:
a panel comprising a pair of screw holes, and
a receptacle connector adapted to be mounted onto the panel for mating with a plug connector having a plurality of first terminals and a shielding shell enclosing the first terminals, said receptacle connector comprising:
an insulative housing comprising a base section and a mating section extending from the base section, the mating portion having at least one opening for receiving the first terminals;
a plurality of second terminals received in the at least one opening for contacting with the first terminals; and
an outer shell having a sleeve enclosing around the mating section, the sleeve and the mating section enclosing a slot therebetween for receiving the shielding shell.

9. The receptacle connector assembly as claimed in claim 8, further including an inner shell comprising a bush enclosing around the mating section of the insulative housing, said bush being adapted to be received in the shielding shell.

10. The receptacle connector assembly as claimed in claim 9, wherein said inner shell is fixed to the insulative housing.

11. The receptacle connector assembly as claimed in claim 8, further including a pair of bolts, and wherein the insulative housing has a pair of fixing portions laterally and oppositely extending from the base section, each fixing portion having a mounting hole for receiving the bolt for fixing the receptacle connector to the panel.

12. The receptacle connector assembly as claimed in claim 11, wherein said outer shell has a pair of fixing plates extending laterally and oppositely from the sleeve, said fixing plates assembled to the fixing portions of the insulative housing.

13. The receptacle connector assembly as claimed in claim 12, wherein the fixing plate includes a through hole aligning to the mounting hole and the screw hole for receiving the bolt.

14. The receptacle connector assembly as claimed in claim 11, wherein the bolt has a headed cap for latching with the plug.

15. An electrical connector assembly for use with a plug connector having a shield with a flange to define a mating portion thereof, comprising:
a panel defining a through opening through opposite front and rear surfaces;
a receptacle connector including:
a base with a mating port extending forwardly therefrom under condition that the base is located behind the rear surface of the panel while the mating port extends through the through opening and forwardly beyond the front surface of the panel for mating with the mating portion of the plug connector;
a plurality of contacts having corresponding contacting sections extending in the mating port; and
a metallic exterior shell fastened to at least one of the panel and the receptacle connector and defining a sleeve circumferentially surrounding the mating port with therebetween a gap which is dimensioned to snugly receive only the flange of the shield of the plug connector.

16. The electrical connector assembly as claimed in claim 15, wherein the receptacle connector comprises an insulatie housing and a metallic interior shell, and the mating port is formed by the interior shell enclosing the housing.

17. The electrical connector assembly as claimed in claim 16, wherein both the exterior shell and the interior shell have corresponding flange structures which are corresponding to the mating port and extending from corresponding planar structures which are corresponding to the base.

18. The electrical connector assembly as claimed in claim 15, wherein the exterior shell is essentially assembled to the front surface of the panel.

19. The electrical connector assembly as claimed in claim 15, wherein the panel, the exterior shell and the receptacle connector are assembled together via a pair of bolts located by two sides of the mating port.

20. The electrical connector assembly as claimed in claim 19, wherein said bolts are configured and dimensioned for locking corresponding latches of the plug which are located by two sides of the mating portion.
